(19) United States
(12) Patent Application Publication
(10) Pub. No.: US 2010/0263260 A1
(43) Pub. Date: Oct. 21, 2010

(54) Device for Attracting Insects

(76) Inventors: Bert Engelbrecht, Christchurch (NZ); Jorg Engelbrecht, Christchurch (NZ)

Correspondence Address: PRIEST & GOLDSTEIN PLLC, 5015 SOUTHPARK DRIVE, SUITE 230, DURHAM, NC, 27713-7736, US

(21) Appl. No.: 12/063,049

(22) PCT Filed: Aug. 3, 2006
(86) PCT No.: PCT/EP06/07668

§ 371 Date: May 27, 2010

(30) Foreign Application Priority Data
Nov. 8, 2005 (EP) 05017446.5

(51) Int. Cl. A01M 1/04; A01M 1/14; A01M 1/10

(52) U.S. Cl. 43/113; 43/114; 43/107

(57) ABSTRACT

The invention relates to a device for attracting insects, a receptacle for a dispenser being provided that is adapted to release at least one chemical attractant. Said receptacle is disposed inside a closed hollow body which has an opening. With this opening, the receptacle can be put over a heat source which also secures the hollow body. The receptacle for the dispenser allows to convert a device for catching flies, which is known per se, into a device for catching midges.

The invention relates to a device for attracting insects according to the preamble of patent claim 1.

For humans and animals flying insects can prove to be genuine pests which need to be fended off.

Apart from the common housefly, the blow-fly should be mentioned, which humans not only perceive as a nuisance but which are also known to be carriers of pathogens. For this reason human beings want to keep these flies away from areas in which food items are located, since flies deposit eggs in them from which emerge maggots, from which, lastly, flies develop again.

In order to protect themselves against these flying insects, flycatchers have already been developed, which are particularly highly effective if they emit ultraviolet light (DE 38 40 440 C2, WO 98/53677) or release chemical attractants (U.S. Pat. No. 5,635,174 A, U.S. Pat. No. 5,770,189 A, EP 0 768 823 B1, U.S. Pat. No. 5,683,687). Since flies are attracted by the ultraviolet light as well as by the attractants, they fly in the direction toward the flycatcher, where they are held in place by the adhesive strip disposed here.

However, mosquitoes are also unwanted by human beings and animals, especially since they transmit diseases which can frequently also be fatal. Unfortunately, these mosquitoes are virtually not at all attracted by ultraviolet light. In addition, in order to attract mosquitoes, other attractants are required than in the case of flies. Catching mosquitoes with conventional flycatchers yields only poor results.

However, it is known that CO₂ is an effective attractant for mosquitoes, since it represents an indication of the presence of warm-blooded animals. Therewith it is possible to attract mosquitoes by means of dry ice (solid CO₂), since dry ice sublimates above −78.5° C. It has thus been proposed to combine a standard light source with a CO₂ source in order to attract mosquitoes (R. R. Carestia and Linnaeus B. Savage, Effectiveness of Carbon Dioxide as a Mosquito Attractant in the CDC Miniature Light Trap, Mosquito News, Vol. 27, 1967, pp. 90-92).

A further mosquito attractant is lactic acid, of which there are three types. It has been found that the dextrorotary lactic acid, the L(+)-lactic acid, a degradation product of the human body, attracts mosquitoes (F. Acree, Jr., R. B. Turner, H. K. Gouck, M. Beroza: L-Lactic Acid: A Mosquito Attractant Isolated from Humans, Science, Vol. 161, 1968, pp. 1346-1347).

To vitamin B or cholesterol, however, has also already been ascribed the capability of attracting mosquitoes (SPIEGEL ONLINE 34/1999).

It has further been found that substituted benzene derivatives, such as also occur in the secretions of flesh-eating plants, not only attract flies and wasps, but also mosquitoes (WO 97/03561).

A catching device for flying insects with which flies as well as also mosquitoes can be caught, utilizes these scientific findings (EP 1 213 958 B1). Like the conventional flycatchers, this catching device comprises an ultraviolet light source (UV light source) with an adhesive strip, wherein, additionally, an open container for a mosquito-attracting substance is provided. Flies as well as mosquitoes are caught by the adhesive strip as soon as they impinge thereon.

Furthermore is known a device for attracting insects which comprises cylindrical bodies with a tube (U.S. Pat. No. 5,943,815 A). This tube has several openings from which CO₂ can escape.

In another known insect trap a heating element is provided which heats a CO₂ source (US 2003/0070345 A1).

An insect trap is, moreover, known which includes a container for an attractant (DE 102 59 651 A1).

Lastly are also known insect traps which include strips or filter papers provided with attractants (WO 00/59300 A; U.S. Pat. No. 4,283,878 A).

The invention addresses the problem of providing a mosquito catching device which has a high capture rate.

This problem is solved according to the features of patent claim 1.

The invention, consequently, relates to a device for attracting insects, wherein a receptacle for a dispenser is provided, which dispenser can release at least one attractant. This receptacle is disposed on a closed hollow body open at one site. With the open site it can be placed over a heat source, which simultaneously serves as a holder for the hollow body. With the aid of the receptacle for the dispenser a device, known per se, for catching flies can be converted into a device for catching mosquitoes.

The advantage attained with the invention comprises in particular that a device for catching flies can be converted to a device for catching mosquitoes utilizing only an additional attachment.

The attachment includes a receptacle into which a dispenser can be set. This dispenser preferably has attractants for mosquitoes, however, it may also include attractants for other insects. Thereby that the dispenser is disposed in the proximity of a UV lamp, the attractants evaporate continuously due to the heat generated by the lamp. The major portion of the heat, however, is not generated by the UV lamp itself, but rather by a ballast unit. By ballast unit is understood a current-limiting device for gas discharge lamps. The ballast unit can be a ballast choke coil. However, an electronic ballast unit can also be utilized.

Replacing the dispenser is very simple in the invention. A multiplicity of adhesive strips disposed on the device according to the invention increases the capture rate not only of the attracted mosquitoes but also of flies.

Embodiment examples of the invention are shown in the drawing and will be explained in further detail in the following. In the drawing depict:

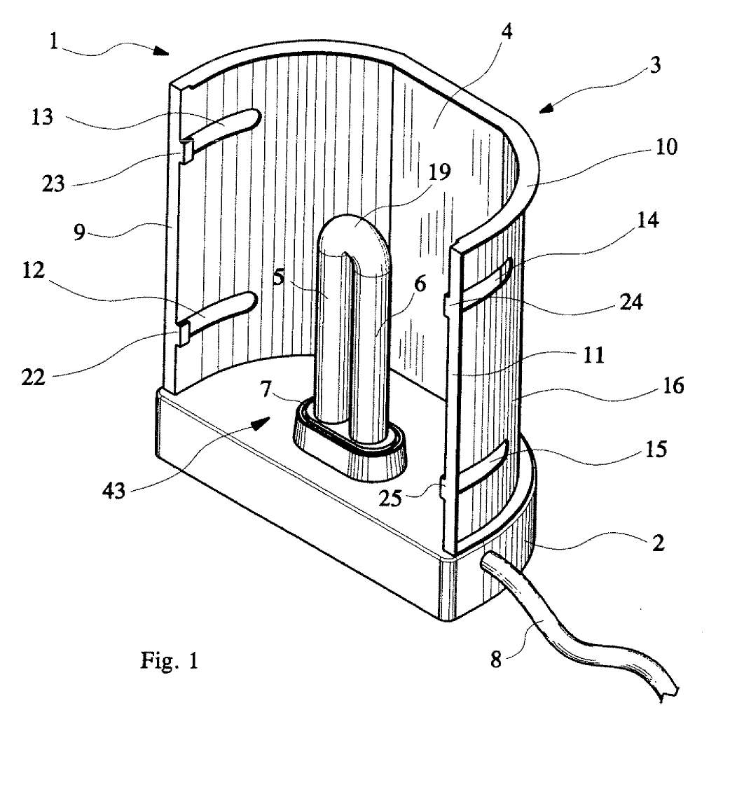

FIG. 1 a perspective view of a framework of a fly catching device known per se,

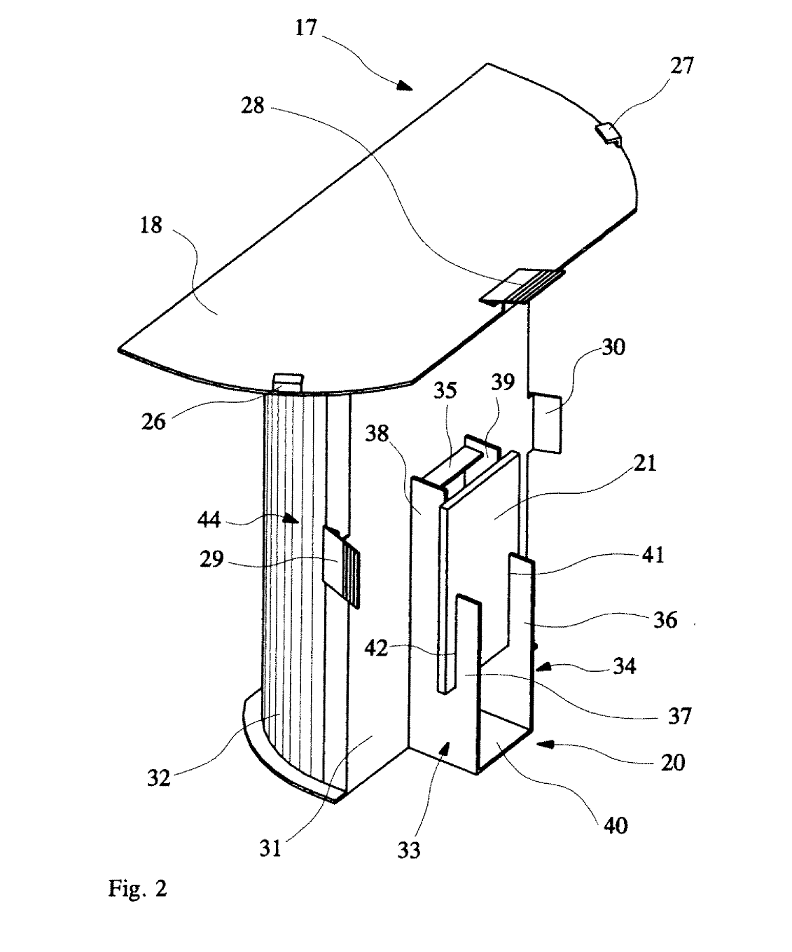

FIG. 2 a perspective view of a mosquito catching device which can be coupled with a fly catching device,

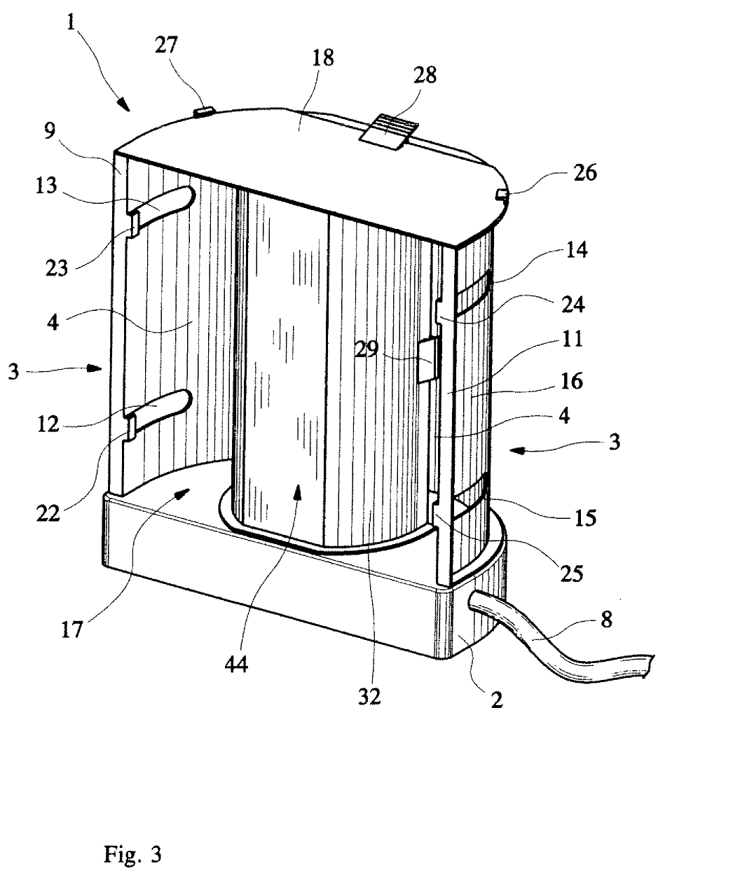

FIG. 3 a perspective view of an insect catching device functioning as a mosquito catching device,

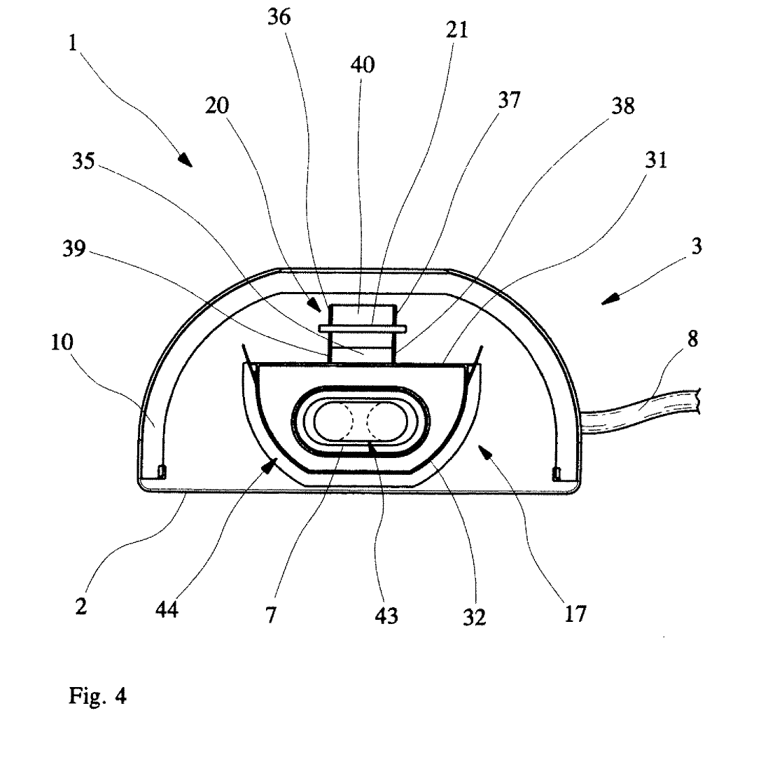

FIG. 4 a top view onto the insect catching device according to FIG. 3 without cover.

FIG. 1 is a perspective view of a framework 3 of a known insect catching device 1 (cf. FIG. 1 and FIG. 4 in EP 1 213 958 B1). The framework 3 comprises a frame 9, 10, 11 disposed on a base 2. The framework 3 thus forms a semi-oval configuration. Frame 9, 10, 11 and base 2 surround a wall 16 with an inner side 4, which includes three regions: two curved regions and one planar region. The inner side 4 of wall 16 serves for receiving an adhesive film, which is in intimate contact on the inner side and is retained by projections 22 to 25. The wall 16 comprises furthermore cutouts 12 to 15, with the aid of which the adhesive film, not shown in FIG. 1, can be readily removed again by pressing onto it.

On base 2 is located a UV light source 43. It is comprised of two tube sections 5, 6 extending parallel to one another, the tube sections 5, 6 being seated on a lamp base 7. Both tube sections 5, 6 are connected with one another through a connection piece 19.

The UV light source 43 is encompassed on three sides by the frame 9, 10, 11 as well as by the inner side 4 of wall 16. On base 2 is further disposed a cable 8 via which the UV light source 43 is supplied with power. A UV light source 43 operated with batteries is also conceivable. However, in the base 2 is preferably located a (not shown) ballast unit, which generates heat.

FIG. 2 shows a mosquito catching device 17 which can be introduced into the insect catching device 1 according to FIG. 1. This mosquito catching device 17 is essentially comprised of a closed hollow body 44 with a cover 18 seated thereon as well as a receiving device 20 disposed on the hollow body 44 for a dispenser 21. This receiving device 20 is disposed on a wall 31 which, after the mosquito catching device 17 is installed into the insect catching device 1 depicted in FIG. 1, forms the rear wall 31. The receiving device 20 for the dispenser 21 has two lateral walls 33, 34 connected with the rear wall 31. Each of these walls 33, 34 has a cutout 41, 42 formed by webs 36 to 39. The cutouts 41, 42 are disposed substantially parallel such that the dispenser 21 can be placed into them and be held by them. Both walls 33, 34 are connected via a bottom 40 as well as a web 35. Through the web 35 the receiving device 20 for the dispenser 21 is additionally stabilized.

After the mosquito catching device 17 is introduced into the framework 3 of the insect catching device 1, the receiving device 20 is located directly in front of the inner side 4 of the insect catching device 1. The cover 18 includes a holder 28 as well as clamping means 26, 27, with which an adhesive film disposed on the cover 18 can be held.

The hollow body 44 of the mosquito catching device 17 includes two sidewalls essentially formed as a semicircle, as well as a front wall, of which in FIG. 2 only the side wall 32 is visible. On the sidewalls and on the front wall can be disposed a further adhesive film which is fastened via holders 29, 30. The adhesive film, consequently, encompasses the hollow body 44 nearly completely.

The dispenser 21 is comprised of a substantially gas-permeable material with minimum pore size. It includes at least one attractant to which respond, in particular, mosquitoes. However, in the dispenser 21 can also be disposed several attractants attracting a wide spectrum of flying insects. The dispenser 21 can be readily replaced by a new one as soon as it loses its effect.

FIG. 3 shows a perspective view of the insect catching device 1 with framework 3 and the installed mosquito catching device 17. Framework 3 as well as the removable mosquito catching device 17 are located on the base 2. The mosquito catching device 17 encompasses the UV radiation source 5, 6, 19 completely.

The frame 9, 10, 11 is adjoined by the wall 16 which forms a substantial portion of the framework 3. The frame 10, however, is not visible here since the cover 18 rests on it. Base 2, frame 9 to 11 and cover 18 are formed substantially semi-ovally. The cover 18 can therefore close off directly with the frame 9, 10, 11; however, it can also, as shown here, have a somewhat different form such that it rests only partially on frame 10.

Three feasibilities for applying adhesive film are evident here. For one, an adhesive film can be disposed on the inner side 4 of wall 16, the film being retained by the projections 22 to 25. This adhesive film serves primarily for catching flies and is white, i.e. it reflects light. However, the adhesive film is black if the insect catching device is utilized as a mosquito catching device. Further, a black adhesive film can be fastened on the cover 18 as well as on the hollow body 44 of the mosquito catching device 17 via holders 28, 29, 30, preferably clips, with only the holders 28, 29 being evident.

In addition to the holder 28, projections 26, 27 are disposed on the cover 18, which serve as guide stops for a film.

The insect catching device can be composed of any desired material. However, it preferably is comprised of synthetic material.

FIG. 4 shows a top view onto the insect catching device 1 without the cover 18 of the mosquito catching device 17.

Evident is the mosquito catching device 17, as it encompasses completely the base 7 with the UV light source 43. On the rear wall 31 of the mosquito catching device 17 the receiving device 20 can be seen with the dispenser 21 disposed thereon. The dispenser 21 is at such proximity to the mosquito catching device 17 that the heat emitted by the UV light source 43 as well as by the ballast unit disposed in the base 2 is sufficient to convert the substances located in the dispenser 21 to the gaseous state. A quantity, which is sufficient for the mosquitoes to detect these released substances, is continuously converted to the gaseous state.

In the following the operation as well as the functional mechanism of the insect catching device 1 will be discussed.

In a first operating mode “Catching Flies” in the insect catching device 1 according to FIG. 1 an adhesive film reflecting light is introduced into the frame 9, 10, 11, and specifically on the inner side 4. The UV light source 5, 6, 19 is now switched on such that flies are attracted by the UV light and get stuck on the adhesive film.

In a second operating mode “Catching Mosquitoes” the mosquito catching device 17 according to FIG. 2—which is entirely black on its outside—is equipped with the dispenser 21, wherein the dispenser 21 is inserted into the receiving device 20. The mosquito catching device 17, whose hollow body 44 is open at the underside, is now placed over the UV light source 5, 6, 19 according to FIG. 1, such that the UV light source 5, 6, 19 is completely enclosed and only functions as a heat source, however, no longer as a light source. Moreover, in base 2 a ballast unit is installed which generates heat. The heat emitted by the light source and by the ballast unit is sufficient for the substance in the dispenser 21 to be slowly and continuously converted to the gaseous state, whereby mosquitoes are attracted.

The mosquitoes thus attracted fly toward the insect catching device 1 and are held in place as soon as they come into contact with an adhesive film.

The mosquito catching device 17 according to FIG. 2 can be viewed as quasi an accessory to the insect catching device 1 according to FIG. 1. Consequently, the insect catching device 1 serves, for one, as a fly catching device and, for another, as a mosquito catching device.

However, it can also operate simultaneously as a mosquito and as a fly catching device. This is possible thereby that the dispenser contains a substance which attracts mosquitoes as well as also flies.

1. Device for attracting insects with a receptacle (20) for a dispenser (21), characterized in that the receptacle (20) is disposed on a closed hollow body (44) having an opening at one site.

2. Device as claimed in claim 1, characterized in that the inner volume of the hollow body (44) is developed such that it can receive a hollow body carrier (5, 6, 19).

3. Device as claimed in claim 1, characterized in that the opening of the hollow body (44) is on an underside.

4. Device as claimed in claim 1, characterized in that the hollow body (44) is closed off on the top side with a cover (18), whose area is at least equal to the cross sectional area of the hollow body (44).

5. Device as claimed in claim 1, characterized in that the hollow body (44) is provided with an adhesive substance on at least one region of its outside.

6. Device as claimed in claim 1, characterized in that on the periphery of the hollow body (44) clip elements (27, 28, 29, 30) are provided for holding adhesive films.

7. Device as claimed in claim 1, characterized in that, viewed from the side, the receptacle (20) has the shape of a U, wherein the one leg (36, 37) of the U is shortened compared to the other leg (38, 39).

8. Device as claimed in claim 7, characterized in that two U-parts (33, 38; 34, 36) are disposed parallel to one another and connected via webs (35, 40).

9. Device as claimed in claim 1, characterized in that the outside of the hollow body (44) is black.

10. Device as claimed in claim 2, characterized in that the hollow body carrier (5, 6, 19) is a heat source disposed on a base (2).

11. Device as claimed in claim 10, characterized in that an additional heat source is located in the base (2).

12. Device as claimed in claim 11, characterized in that the additional heat source is a ballast unit.

13. Device as claimed in claim 2, characterized in that the hollow body carrier (5, 6, 19) is a UV light source (43).

14. Device as claimed in claim 10, characterized in that the hollow body carrier (5, 6, 19) and the base (2) are parts of an insect catching device (1) which includes a framework (3) for receiving adhesive films.
